(19) United States
(12) Patent Application Publication
(10) Pub. No.: US 2015/0130599 A1
(43) Pub. Date: May 14, 2015

(54) TRAINING SYSTEM

(71) Applicant: MIMIC TECHNOLOGIES, INC., SEATTLE, WA (US)

(72) Inventors: Jeffrey J. Berkley, Seattle, WA (US); Seahak Kim, Seattle, WA (US)

(73) Assignee: MIMIC TECHNOLOGIES, INC., SEATTLE, WA (US)

(21) Appl. No.: 14/077,228

(22) Filed: Nov. 12, 2013

(51) Int. Cl. G08B 6/00

(52) U.S. Cl. CPC G08B 6/00
USPC 340/407.2

(57) ABSTRACT

A haptic interface device may be included in a simulator/slave controller system, which may be operated in simulator-mode or slave-controller mode. In simulator-mode, the haptic interface device may be utilized to control a virtual slave. In slave-controller mode, the haptic interface device may be utilized to control a real-world slave. The haptic interface device may include a plurality of ports, which may be movable with respect to each other. The haptic interface device may be configured to be operable in a plurality of configurations.

### BACKGROUND

1. Technical Field

This disclosure is generally related to haptic systems, and more particularly to haptic systems employing force feedback provided through selective and dynamic tensioning of cables.

2. Description of the Related Art

Touch, or haptic interaction is a fundamental way in which people perceive and effect change in the world around them. Our very understanding of the physics and geometry of the world begins by touching and physically interacting with objects in our environment. The human hand is a versatile organ that is able to press, grasp, squeeze or stroke objects; it can explore object properties such as surface texture, shape and softness; and it can manipulate tools such as a pen or wrench. Moreover, touch interaction differs fundamentally from all other sensory modalities in that it is intrinsically bilateral. We exchange energy between the physical world and ourselves as we push on it and it pushes back. Our ability to paint, sculpt and play musical instruments, among other things depends on physically performing the task and learning from the interactions.

Haptics is a recent enhancement to virtual environments allowing users to “touch” and feel the simulated objects with which they interact. Haptics is the science of touch. The word derives from the Greek haptikos meaning “being able to come into contact with.” The study of haptics emerged from advances in virtual-reality. Virtual-reality is a form of human-computer interaction (as opposed to keyboard, mouse and monitor) providing a virtual environment that one can explore through direct interaction with our senses. To be able to interact with an environment, there must be feedback. For example, the user should be able to touch a virtual object and feel a response from it. This type of feedback is called haptic feedback.

In human-computer interaction, haptic feedback refers both to tactile and force feedback. Tactile, or touch feedback is the term applied to sensations felt by the skin. Tactile feedback allows users to feel things such as the texture of virtual surfaces, temperature and vibration. Force feedback reproduces directional forces that can result from solid boundaries, the weight of grasped virtual objects, mechanical compliance of an object and inertia.

Conventional haptic devices (or haptic interfaces) are typically mechanical devices that mediate communication between the user and the computer. Haptic devices allow users to touch, feel and manipulate three-dimensional objects in virtual environments and tele-operated systems. Most common computer interface devices, such as basic mice and joysticks, are input-only devices, meaning that they track a user's physical manipulations but provide no manual feedback. As a result, information flows in only one direction, from the peripheral to the computer. Haptic devices are input-output devices, meaning that they track a user's physical manipulations (input) and provide realistic touch sensations coordinated with on-screen events (output). Examples of haptic devices include consumer peripheral devices equipped with special motors and sensors (e.g., force feedback joysticks and steering wheels) and more sophisticated devices designed for industrial, medical or scientific applications (e.g., PHANTOM™ device).

Haptic interfaces are relatively sophisticated devices. As a user manipulates the end effecter, grip or handle on a haptic device, encoder output is transmitted to an interface controller. Here the information is processed to determine the position of the end effecter. The position is then sent to the host computer running a supporting software application. If the supporting software determines that a reaction force is required, the host computer sends feedback forces to the device. Actuators (motors within the device) apply these forces based on mathematical models that simulate the desired sensations. For example, when simulating the feel of a rigid wall with a force feedback joystick, motors within the joystick apply forces that simulate the feel of encountering the wall. As the user moves the joystick to penetrate the wall, the motors apply a force that resists the penetration. The farther the user penetrates the wall, the harder the motors push back to force the joystick back to the wall surface. The end result is a sensation that feels like a physical encounter with an obstacle.

General-purpose commercial haptic interfaces used today can be classified as either ground based devices (force reflecting joysticks and linkage based devices) or body based devices (gloves, suits, exoskeletal devices). The most popular design on the market is a linkage based system, which consists of a robotic arm attached to a grip (usually a pen). A large variety of linkage based haptic devices have been patented (examples include U.S. Pat. Nos. 5,389,865; 5,576,727; 5,577,981; 5,587,937; 5,709,219; 5,828,813; 6,281,651; 6,413,229; and 6,417,638).

An alternative to a linkage based device is one that is tension based. Instead of applying force through links, cables are connected a point on a “grip” in order to exert a vector force on that grip. Encoders can be used to determine the lengths of the connecting cables, which in turn can be used to establish position of the cable connection point on the grip. Motors are used to create tension in the cables.

Predating Dr. Seahak Kim's work on the SPIDAR-G, Japanese Patent No. 2771010 and U.S. Pat. No. 5,305,429 were filed that describe a “3D input device” as titled in the patent. This system consists of a support means, display means and control means. The support means is a cubic frame. Attached to the frame are four encoders and magnetic switches capable of preventing string movement over a set of pulleys. The pulleys connect the tip of each encoder to strings that are wound through the pulleys. Each string continues out of the pulley to connect with a weight that generates passive tension in the string. The ON/OFF magnetic switches allow the strings to be clamped in place on command from the host computer. The strings connect to the user's fingertip, which are connected to the weights through the pulleys. The user moves his or her fingertip to manipulate a virtual object in a virtual environment, which is displayed through a monitor. As the user moves his or her fingertip, the length of the four strings change, and a computer calculates a three-dimensional position based on the number of pulses from the encoder, which indicate the change of string length between the pulleys and the user's finger. If the three-dimensional position of the fingertip is found to collide with a virtual object as determined by a controlling host computer, then the ON/OFF magnetic switch is signaled to grasp and hold each string so that movement is resisted. Forces are not rendered in a specific direction, but resistance in all directions indicates that a user has contacted a virtual object. When the fingertip is forced outside the boundary of a virtual object, the magnetic switch is turned off to release the strings. The user is then able to move his or her finger freely.

A system that combines virtual-reality with exercise is described in U.S. Pat. No. 5,577,981. This system uses sets of three cables with retracting pulleys and encoders to determine the position of points on a head mounted display. Using the lengths of the three cables, the position of the point in space is found. Tracking three points on the helmet (nine cables) allows head tracking of six degrees of freedom. Three cables attached to motor and encoders are also used to control the movement of a boom that rotates in one dimension through a vertical slit in a wall. The boom also has a servomotor at its end, about which the boom rotates. It is claimed that the force and direction of force applied by the boom can be controlled via the cables, servo motor and computer software, but no details are provided for how this is accomplished. U.S. Pat. No. 5,305,429 and U.S. Pat. No. 6,630,923 describe two cables based haptic interface devices.

Haptic interface devices can be used in a variety of fields for a variety of purposes. One field where haptic interface devices are currently employed is in simulating medical procedures for training medical personnel such as doctors in new techniques and/or for allowing medical personnel to practice old techniques. The practice of old or new techniques via a haptic interface device is especially important when the techniques are complicated and/or inherently risky to patients. Normally, conventional haptic interface devices can be large and for all practical purposes non-portable. Thus, hospitals and organizations that use a conventional haptic interface device normally dedicate a room for the conventional haptic interface device. This means that persons wanting or needing to use a conventional haptic interface device must go to the dedicated room in order to practice on the conventional haptic interface device, which can be very inconvenient to the persons wanting or needing to use the conventional haptic interface device. A problem with conventional haptic interface devices is that they may be under-utilized due to the inconvenience of the user having to go to the dedicated room. Another problem is that hospitals and other organizations might not have the resources for housing the conventional haptic interface devices. Thus, there exists a need to overcome the aforementioned deficiencies.

Robotic systems are used in various fields such as surgery. Surgeons need to not only learn surgical techniques and procedures, but to also learn how to control and utilize the robotic systems. However, these systems are very expensive and require a good deal of training, and while these systems are being utilized for training of surgeons, they cannot be utilized for performing actual surgeries on patients.

In some surgical procedures, a team of surgeons may perform a procedure. One surgeon, a robot-side surgeon, may operate a robotic surgical system and another surgeon, a patient-side surgeon, may perform patient-side tasks and procedures. The patient-side surgeon may, for example, utilize laparoscopic equipment to perform various surgical tasks. The patient-side surgeon must perform these tasks while the robot-side surgeon is utilizing the robotic surgical system. Consequently, the patient-side surgeon must perform these tasks without interfering with the robotic surgical system.

What is need is a way to allow users of robotic systems to learn procedures that are implemented using a robotic system without accessing a robotic system.

What is also needed is a way to train teams of operators where some team members operate a robotic system and other team members operate auxiliary equipment that is proximal to a robot.

### BRIEF DESCRIPTION OF THE DRAWINGS

The detailed description is described with reference to the accompanying figures. In the figures, the left-most digit(s) of a reference number identifies the figure in which the reference number first appears.

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of an example illustrative environment to operate a master-slave system and a slave-side auxiliary system and to practice team work and the operation of master-slave system and/or slave-side auxiliary system in accordance with one illustrated embodiment.

FIG. 2 is a schematic diagram of an example illustrative simulator/slave controller system of FIG. 1, in accordance with one illustrated embodiment.

FIG. 3 is a block diagram of an illustrative computing device that may be utilized in the environment of FIG. 1.

FIGS. 4A-4D are isometric views of an example haptic interface device in accordance with one illustrated embodiment.

FIGS. 5A and 5B are front and side views of internal components of the example haptic interface device of FIGS. 4A-4D.

FIG. 6 shows a side view of an example tool in accordance with one illustrated embodiment.

FIG. 7A is a side view of an example cable-based effector unit tool in accordance with one illustrated embodiment, and FIG. 7B shows an enlarged portion of FIG. 7A.

FIG. 8 is a flow diagram of an example process to calibrate the haptic interface device.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with systems and methods for providing virtual-reality using cable based haptic interface devices have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

### Overview

This disclosure describes techniques for training trainees in the use of surgical equipment such as laparoscopic equipment and in performing surgical procedures, surgical procedures within the context of a team environment, and surgical procedures that employ a robotic surgical system with a patient-side assist station.

This disclosure also describes techniques for controlling a robotic slave of a master-slave system with a cable based user interface system. In some embodiments, the cable based user interface system may provide a user with haptic feedback.

### Example Environment

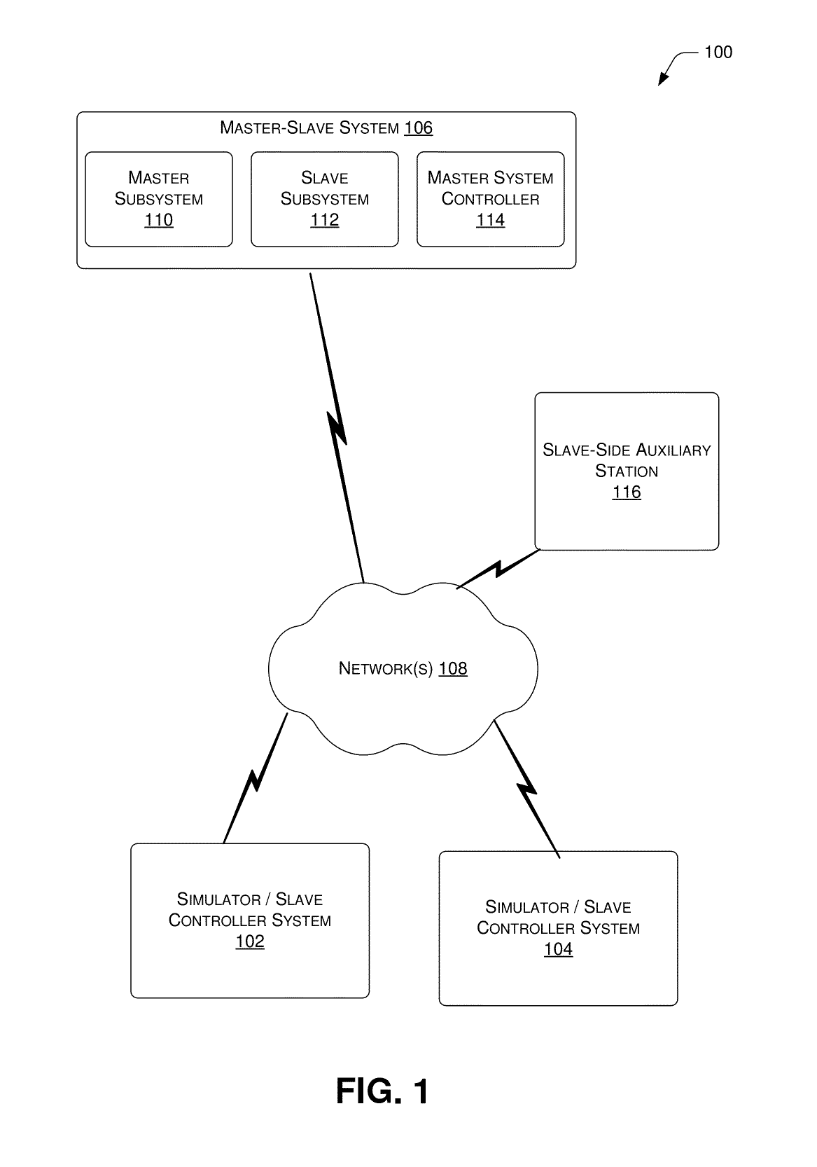

FIG. 1 is a schematic diagram of an environment 100 for surgical training in accordance with one illustrated embodiment. The environment 100 includes a simulator system/slave controller 102, and in some embodiments, the environment 100 may include at least one more simulator system/slave controller 104, and may include a master-slave system 106, and one or more networks 108.

The network(s) 108 may include wired and/or wireless networks that enable communications between the various entities in the environment 100. In some embodiments, the network(s) 108 may include local area networks (LANs), wide area networks (WAN), mobile telephone networks (MTNs), other types of networks including wireless networks such as, but not limited to, IEEE 802, and data connection modalities such as through USB, firewire, parallel ports, serial port, etc., possibly used in conjunction with one another, to facilitate communication between the simulator system/slave controller 102, the simulator system/slave controller 104, and the master-slave system 106 and/or to provide internet and/or cloud functionality.

The master-slave system 106 may be robotic systems, telerobotic systems, and/or telepresence systems and may include a master subsystem 110, a slave subsystem 112, and a master system controller 114. The master subsystem 110 may provide a user interface with which a user may provide input and receive output. The master system controller 114 may receive, among other things, control signals from the master subsystem 110 for controlling the slave subsystem 112. The slave subsystem 112 may receive, via the master system controller 114, control signals for driving the slave subsystem 112. The slave subsystem 112 may be driven to match user input provided at the master subsystem 110. The slave subsystem 112 may acquire data and provide the data, via the master system controller 114 to the master subsystem 110.

In some embodiments, the environment 100 may further include a slave-side auxiliary station 116, which may be located in proximity to the slave subsystem 112.

The master system controller 114 may be located in proximity to the master subsystem 110 or the slave subsystem 112, and the master system controller 114 may facilitate communications between the slave-side auxiliary station 116 and the master subsystem 110.

In some instances, the slave subsystem 112 and the slave-side auxiliary station 116, if included, may be located at a facility that is remote from the master subsystem 110. In some instances, the slave subsystem 112 and the slave-side auxiliary station 116, if included, and the master subsystem 110 may be located at one facility.

The slave-side auxiliary station 116 may be employed to provide functionality to supplement the slave subsystem 112. In some instances, the slave-side auxiliary station 116 may operate independent of control signals from the master subsystem 110. In some instances, the slave-side auxiliary station 116 may operate in conjunction with the master subsystem 110. For example, the master subsystem 110 may be operated by a first user and the slave-side auxiliary station 116 may be operated by a second user. In some instances, the second user may perform tasks independent of the first user. In other instances, the second user may perform tasks under the direction of the first user, or vice-versa. In some embodiments, the slave-side auxiliary station 116 may be a master-slave system.

As one non-limiting example, aspects of the environment 100 are described hereinbelow with respect to the master-slave system 102 may being a robotic system for performing surgery. However, such discussion is non-limiting. The master-slave system 106 may be a surgical robotic system. The master subsystem 110 may include, among other thing, input devices for manipulating surgical devices (including the slave subsystem 112) and communication devices that enable communication between a robot-side surgeon, i.e., user of the master-slave system 106, and a patient-side surgeon, i.e., user of the slave-side auxiliary station 116. Ideally, the robot-side surgeon and the patient-side surgeon work as a members of an operating team with each team member communicating with the other so as to provide patient status information and instructions to the other and/or to other operating team members. The master subsystem 110 may also include display devices for allowing the robot-side to observe, among other things, surgical devices being manipulated by the robot-side surgeon and/or by the patient-side surgeon.

In embodiments in which the master-slave system 106 is a surgical robotic system, the slave-side auxiliary station 116 may be a patient-side assist station at which the patient-side surgeon may assist in the performance of a surgical procedure being performed by the surgical robotic system. In some instances, the patient-side surgeon may be located in close proximity to the patient and to the slave subsystem 112 and may be manipulating surgical devices such as laparoscopic instruments and tools. In this case, the patient-side surgeon may need to be in a fixed position to properly observe patient monitors and display devices. It should be noted that the fixed position may be determined in part on preventing interference between the slave subsystem 112 and the patient-side surgeon.

In some embodiments, the simulator/slave controller systems 102 and 104 may be operated in either simulator mode of slave controller mode. In slave controller mode, a user of the simulator/slave controller system 102 may control operation of the slave subsystem 112, and a user of the simulator/slave controller system 104 may control operation of the slave-side auxiliary station 116 provided that the slave-side auxiliary station 116 includes a corresponding slave subsystem.

In simulator mode, the simulator/slave controller systems 102 and 104 may be used to simulate the individual or joint operation of the master-slave system 106 and the slave-side auxiliary station 116. For example, the simulator/slave controller systems 102 may simulate operation of the master-slave system 106, and the simulator/slave controller systems 104 may simulate operation of the slave-side auxiliary station 116. The users of the simulator/slave controller systems 102 and 104 may communicate with each other over the networks 108.

As another example, the simulator/slave controller system 102 may be used to simulate operation of either the master-slave system 106 or the slave-side auxiliary station 116.

As another example, the simulator/slave controller system 102 may be used to simulate operation of a non-robotic station such as a standalone laparoscopy station.

### Example Simulator/Slave Controller System

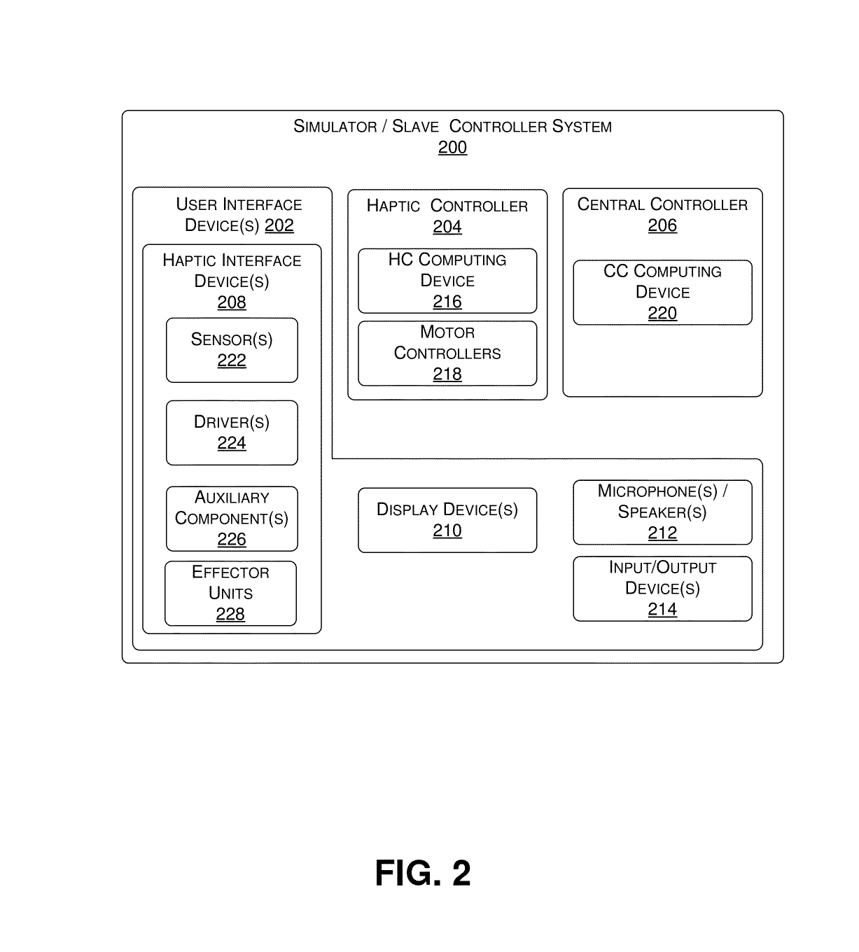

FIG. 2 shows a schematic of an example simulator/slave controller system 200 that may be implemented by the simulator/slave controller systems 102 and/or 104 in the environment 100, according to one illustrated embodiment.

The simulator/slave controller system 200 may include a user interface device (or devices) 202, a haptic controller 204, and a central controller 206. The user interface device 202 may include a haptic interface device (or devices) 208, one or more display devices 210, one or more microphones/speaker 212, and input/output devices 214. Input/output devices 214 may include keyboard, mouse, microphone, touch sensitive display, motion tracking systems, foot pedals, etc.

The microphones/speakers 212 may pick-up utterances and other noises, which may be provided to the central controller 206, and may provide audible noises. In some instances, a user of the simulator/slave controller system 200 may communicate with another user/person via the microphones/speakers 212, and in other instances, the user of the simulator/slave controller system 200 may communicate with a voice-recognition system. In some instances, the voice-recognition system may provide an interface for controlling the simulator/slave controller system 200. For example, the user may provide commands to an operating system of the simulator/slave controller system 200 such as “activate mouse” or selecting an item from a menu, etc. In some embodiments, some input devices may be multifunctional and may be switched between functions by commands that “activate” specific functions.

In some instances, the voice-recognition system may provide an interface for testing a trainee/user of the simulator/slave controller system 200. For example, the voice-recognition system may query the trainee/user and evaluate the trainee's/user's responses.

The display devices 210 may include liquid crystal display (LCD) devices, flat screen devices, plasma display devices, light emitting diode (LED) devices, stereoscopic devices, heads up displays, virtual-reality headsets, etc. In some instances, such as when the simulator/slave controller system 200 is in simulator mode, the display devices 210 may provide images of a virtual slave. In other instances, such as when the simulator/slave controller system 200 is in slave-controller mode, the display devices 210 may provide images the slave subsystem 112. In some instances, such as when the user wears a virtual-reality headset, the user may be provided with images of the slave-side auxiliary station 116 and with images of the slave subsystem 112. The user may gain virtual experience of working at the slave-side auxiliary station 116 in close proximity to the slave subsystem 112. For example, a user may wear a virtual-reality headset and be provided with virtual-reality (or augmented-reality) images of a patient (or portions of a patient) and a robot or portions of a robot. The virtual/augmented—reality environment may assist in training the user to work with the robot. For example, the user will learn that he or she cannot work on the patient from a certain location because the presence of an actual robot impedes the user's access to the patient, or as another example, an actual robot may be prone towards colliding with the user when the user is positioned at certain locations.

The haptic interface device 208 may be utilized by a user of the simulator/slave controller system 200 to provide input to the simulator/slave controller system 200. The user may grasp and manipulate grips (not shown) for controlling a virtual slave and/or the slave subsystem 112. In some instances, the haptic interface device 208 may provide force feedback to the user.

The haptic controller 204 may include a haptic controller (HC) computing device 216 and motor controllers 218. The motor controllers 218 may receive input signals from the user interface device 202. The input signals may correspond to user inputs provided at the haptic interface device 208. The motor controllers 218 may provide the haptic interface device 208 with control signals. In some instances, the motor controllers 218 may also provide force feedback signals to the haptic interface device 208.

The HC computing device 216 may utilize the received input signals and generate the control/force feedback signals for the haptic interface device 208. In some embodiments, the HC computing device 216 may include instructions and data for providing simulations of procedures/tasks performed, individually and/or jointly, by the master-slave system 106 and the slave-side auxiliary station 116. In some embodiments, the HC computing device 216 may include simulation data such as, but not limited to, virtual-reality primitives, which may provide a skeletal frame of virtual-reality objects. The HC computing device 216 may utilize the virtual-reality primitives to, among other things, determine collisions between virtual-reality objects such as collisions between a virtual slave manipulated by a user of the haptic interface device and other virtual objects. In some instances, the HC computing device 216 may provide primitive virtual-reality information to the central controller 206.

The central controller 206 may include a central controller (CC) computing device 220 and may receive signals from the haptic controller 204, the user interface device 202, and from external systems such as, but not limited to, the master-slave system 106 and/or another simulator/slave controller system (e.g., simulator/slave controller systems 102 and 104 may be in communication with each other). The signals from the haptic controller 204 may correspond to manipulations of a virtual slave and/or the slave subsystem 112. The signals from the user interface device 202 may include user inputs provided by the microphones 212 and/or the input devices 214. The central controller 206 may, among other things, generate images for display on the display devices 210, generate audio signals for the speakers 212. In some instances, the signals from the haptic controller 204 may include primitive virtual-reality information. The central controller 206 may utilize the primitive virtual-reality information to generate a virtual-reality environment. For example, the central controller 206 provide surfaces, texture, coloring, lighting, etc., to primitive virtual-reality objects based on the received primitive virtual-reality information. The virtual-reality environment may then be displayed on the display devices 210.

In some embodiments, the central controller 206 may receive signals corresponding to audible commands, requests, informational statements, etc. The central controller 206 may include a voice recognition system, which may interpret the commands, requests, informational statements, etc. The central controller 206 may then respond to the commands, requests, informational statements, etc. in accordance with a set of rules. For example, in some instances, the central controller 206 may query a user of the simulator/slave controller system 200 for information e.g., “name the highlighted organ,” and in that case, the central controller 206 may interpret the user's responsive informational statement e.g., “kidney.”

In some embodiments, the central controller 206 may calibrate/recalibrate the haptic interface device 208. The calibration/recalibration of the haptic interface device 208 may occur at predefined events, e.g., upon start up, at predefined intervals of time, e.g., every day, upon detection of a potential error in the calibration of the haptic interface device 208, and/or on-the-fly, i.e., the haptic interface device 208 may be recalibrated while being operated by a user.

In some embodiments, the haptic interface device 208 may include one or more sensors 222. In some instances, the sensors 222 may include magnetometers, accelerometers, gyroscopes, encoders, optical devices, acoustic devices, pressure devices, etc. The sensors 222 may gather operational data such as, but not limited to, position and/or orientation data of a tool, user position data, etc.

The haptic interface device 208 may include one or more drivers 224 for, among other things, configuring the haptic interface device 208. The drivers 208 may configure the haptic interface device 208 to be in a specific orientation relative to a fixed user position based at least in part on a task/procedure for which the haptic interface device 208 is being utilized. For example, the haptic interface device 208 may be used in simulating surgical procedures, and the drivers 224 may configure the haptic interface device 208 based at least in part on a type of surgical procedure being simulated. In some instances, the drivers 224 may provide two degrees of rotational freedom to one or more portions of the haptic interface device 208. In some instances, the drivers 224 may translate one or more portions of the haptic interface device 208. For example, the drivers 224 may cause relative motion between one or more ports of the haptic interface device 208.

In some embodiments, the haptic interface device 208 may include auxiliary components 226. In some instances, the auxiliary components 226 may include may be components that a real world user of the slave-side auxiliary station 116 may encounter. For example, when the slave-side auxiliary station 116 is a patient-side laparoscopic station, auxiliary components may include a camera port and/or a camera and may include components that are not part of the patient-side laparoscopic station such as, but not limited to, arms of a robotic surgical system. In some embodiments, the auxiliary components may be removably coupled to the haptic interface device 208 and may be attached or removed based at least in part on how the haptic interface device is being utilized, e.g., depending on a type of simulation being performed.

In some embodiments, the haptic interface device 208 may include effector units 228. Effector units 228 may include a number of cable tensioner assemblies for applying tension to cable segments coupled to a tool being manipulated by a user. The cable tensioner assemblies may include motors, pulleys, brakes, sensors, cable guides, spools, etc. for playing out and retracting cable segments. The effector units 228 may provide and receive signals to and from the motor controllers 218.

### Example Computing Device

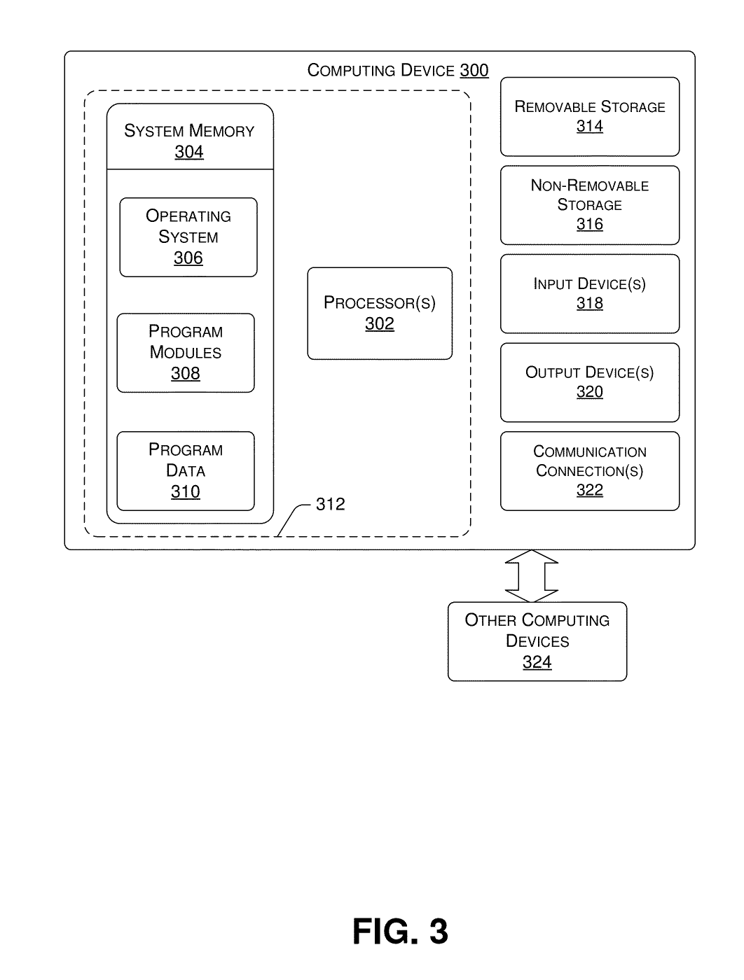

FIG. 3 shows an illustrative computing device 300, according to one illustrated embodiment, that may be used to implement the HC computing device 216 and/or the CC computing device 220. It will readily be appreciated that the various embodiments described above may be implemented in other computing devices, systems, and environments. The computing device 300 shown in FIG. 3 is only one example of a computing device and is not intended to suggest any limitation as to the scope of use or functionality of the computer and network architectures. The computing device 300 is not intended to be interpreted as having any dependency or requirement relating to any one or combination of components illustrated in the example computing device.

In a very basic configuration, the computing device 300 typically includes at least one processor 302 and system memory 304. Depending on the exact configuration and type of computing device, the system memory 304 may be volatile (such as RAM), non-volatile (such as ROM, flash memory, etc.) or some combination of the two. The system memory 304 typically includes an operating system 306, one or more program modules 308, and may include program data 310. The computing device 300 is of a very basic configuration demarcated by a dashed line 312.

The computing device 300 may have additional features or functionality. For example, the computing device 300 may also include additional data storage devices (removable and/or non-removable) such as, for example, magnetic disks, optical disks, or tape. Such additional storage is illustrated in FIG. 3 by removable storage 314 and non-removable storage 316. Computer-readable media may include, at least, two types of computer-readable media, namely computer storage media and communication media. Computer storage media may include volatile and non-volatile, removable, and non-removable media implemented in any method or technology for storage of information, such as computer readable instructions, data structures, program modules, or other data. The system memory 304, the removable storage 314 and the non-removable storage 316 are all examples of computer storage media. Computer storage media includes, but is not limited to, RAM, ROM, EEPROM, flash memory or other memory technology, CD-ROM, digital versatile disks (DVD), or other optical storage, magnetic cassettes, magnetic tape, magnetic disk storage or other magnetic storage devices, or any other non-transmission medium that can be used to store the desired information and which can be accessed by the computing device 300. Any such computer storage media may be part of the computing device 300. Moreover, the computer-readable media may include computer-executable instructions that, when executed by the processor(s) 302, perform various functions and/or operations described herein.

In contrast, communication media may embody computer-readable instructions, data structures, program modules, or other data in a modulated data signal, such as a carrier wave, or other transmission mechanism. As defined herein, computer storage media does not include communication media.

The computing device 300 may also have input device(s) 318 such as keyboard, mouse, pen, voice input device, touch input device, etc. Output device(s) 320 such as a display, speakers, printer, etc. may also be included. These devices are well known in the art and are not discussed at length here. In some embodiments, the input device(s) 318 and the output device(s) 320 may be implemented by the user interface device(s) 202.

The computing device 300 may also contain communication device(s) 322 that allow the computing device 300 to communicate with other computing devices 324, such as over a network. These networks may include wired networks as well as wireless networks. The communication device(s) 322 are one example of communication media. In some embodiments, the communication device(s) 322 may provide connections such as, but not limited to, universal serial bus (USB), firewire (IEEE 1394), Ethernet, etc.

It is appreciated that the illustrated computing device 300 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

When the HC computing device 216 is implemented by the computing device 300, the program modules 308 may include, among other things, tool-position/orientation modules, virtual-reality modules, force/tension modules, and calibration/recalibration modules, etc. and the program data 310 may include, among other things, virtual-reality primitives (e.g., skeletal shapes of virtual objects), reference calibration point(s), reference sensor values, etc.

The tool-position/orientation modules may include instructions for determining positions and orientations of tools (or a tool) being manipulated by a user of the simulator/slave controller system 102. The tool-position/orientation modules may utilize sensor-data acquired by sensors of the haptic interface device 204 to determine positions and/or orientations of the tools and/or to track movement of same. In some embodiments, the tool-position/orientation modules may utilize, among other things, relative differences between current sensor-data and reference sensor-data to determine positions and/or orientations of the tools and/or to track movement of same. In some embodiments, the sensor-data may include data from a variety of different sensors, which may send sensor-data at a variety of different rates. For example, some sensors (e.g., fast-refresh sensors) may send sensor-data at a first refresh rate and other sensors (e.g., slow-refresh sensors) may send sensor-data at a second refresh rate, which is slower that the first refresh rate. In some instances, the first refresh rate may in the range of 2-20,000 times faster than the second refresh rate. The tool-position/orientation modules may be configured to utilize the most current sensor-data when determining the current positions and/or orientations of the tools and/or tracking movement of same. For example, in some instances, the tool-position/orientation modules may determine current tool positions and/or orientations multiple times utilizing sensor-data from fast-refresh sensors and then determine current tool positions and/or orientations utilizing both sensor-data from both fast-refresh sensors and slow-refresh sensors, when the sensor-data from the slow-refresh sensors is available.

The virtual-reality modules may include instructions for determining collisions of virtual-objects within a virtual-reality environment. The program data 310 may include virtual-reality primitives of virtual-objects within the virtual-reality environment.

The force/tension modules may include instructions for applying a net force to the tool or tools being manipulated by the user of the simulator/slave controller system 102. In some instances, the net force applied to the tool/tools may be such the user feels little or no resistance or little or no inertia associated with moving the tool/tools. In other instances, the net force may be applied such that the user feels force feed-back.

The calibration/recalibration modules may include instructions for calibration and/or recalibrating the haptic interface device 204. For example, calibration/recalibration modules may apply a net force to a tool, which causes a reference portion of a tool to move to a reference location. The reference location may be stored in the program data 310. The calibration/recalibration modules may utilize sensor-data determine an orientation of the tool at the reference location and may record various sensor values while the tool is at the reference location. The recorded sensor values may be utilized by the tool-position/orientation modules as reference sensor-data. In some instances, the calibration/recalibration modules may calibrate the haptic interface device 204 responsive to a change in a power state of the simulator/slave controller system 102 and/or the haptic interface device 204. For example, calibration may occur when the power changes upward, e.g., the simulator/slave controller system 102 and/or the haptic interface device 204 is turned on; and/or the simulator/slave controller system 102 and/or the haptic interface device 204 is awoken from sleep-mode.

In some embodiments, the calibration/recalibration modules may include instructions for recalibrating the haptic interface device 204 on the fly, i.e., while the simulator/slave controller system 102 is in operational mode. In some embodiments, the calibration/recalibration modules may utilize sensor-data from one or more sensors for determining a current position/orientation of a tool and may update reference sensor-data and/or reference tool position data utilized by the tool-position/orientation modules based at least in part on sensor-data from one or more other sensors.

When the CC computing device 220 is implemented by the computing device 300, the program modules 308 may include virtual-reality modules for providing a virtual-reality environment, and the program data 310 may include virtual-reality data (e.g., virtual-reality object colors, lighting, textures, reflectivity, sounds, etc.). In some instances, the virtual-reality modules may utilize the program data and primitive virtual-reality information from the HC computing device 216 to provide a virtual-reality environment to a user of the simulator/slave controller system 102.

When the CC computing device 220 is implemented by the computing device 300, the program modules 308 may include voice recognition modules, which may be utilized to interact with a user of the simulator/slave controller system 102.

### Example Haptic Controller—Controller Communications

In some embodiments, the operating system of the CC computing device 220 may be an event-driven operating system, and the operating system of the HC computing device 216 may be a real-time operating system. (In event-driven operating systems, tasks are switched only when an event of higher priority needs servicing, and in real-time operating systems, data is processed as it comes in, typically without delay.) The difference in the operating systems may not be significant in most situations. However, when the HC computing device 216 needs to communicate information at a high refresh rate to the CC computing device 220, the differences in their respective operating systems may be significant.

In some embodiments, the communications connections 324 of the HC computing device 216 and the CC computing device 220 may include USB devices. The HC computing device 216 and the CC computing device 220 may be configured to allow the HC computing device 216 to communicate information (such as, but not limited to, primitive virtual-reality information) to the HC computing device 220 at a predetermined packet frequency. In some instances, the HC computing device 216 may generate communication packets, which do not exceed a simulator/slave controller system (SSCS) maximum packet size. The HC computing device 216 may include a buffer, such as first-in/first-out (FIFO) buffer, where the communication packets may be buffered, and the HC computing device 216 may transmit these communication packets at the predetermined SSCS packet frequency to the CC computing device 220. In such instances, the maximum packet size may be less than an industry standard maximum packet size. For example, the industry standard maximum packet size for a high speed USB device may be 1024 bytes based on mode (e.g., bulk, interrupt, isochronous), but the SSCS maximum packet size may be much smaller even when the HC computing device 216 and the CC computing device 220 communicate via USB devices. For example, the SSCS maximum packet size may be 512 bytes. In some instances, the SSCS maximum packet size may be set to a desired throughput (e.g., USB 2.0 may have a throughput of 480 Mbits/sec) divided by the SSCS packet frequency.

The CC computing device 220 may include a timer, which may be set to the SSCS packet frequency. Communication packets from the HC computing device 220 are received by CC computing device 220 and may, in some embodiments, be placed in a buffer such as a FIFO buffer. The timer may provide timing signals to the operating system of the CC computing device 220 to cause the communication packets to be processed by the CC computing device 220.

### Example Haptic Interface Device

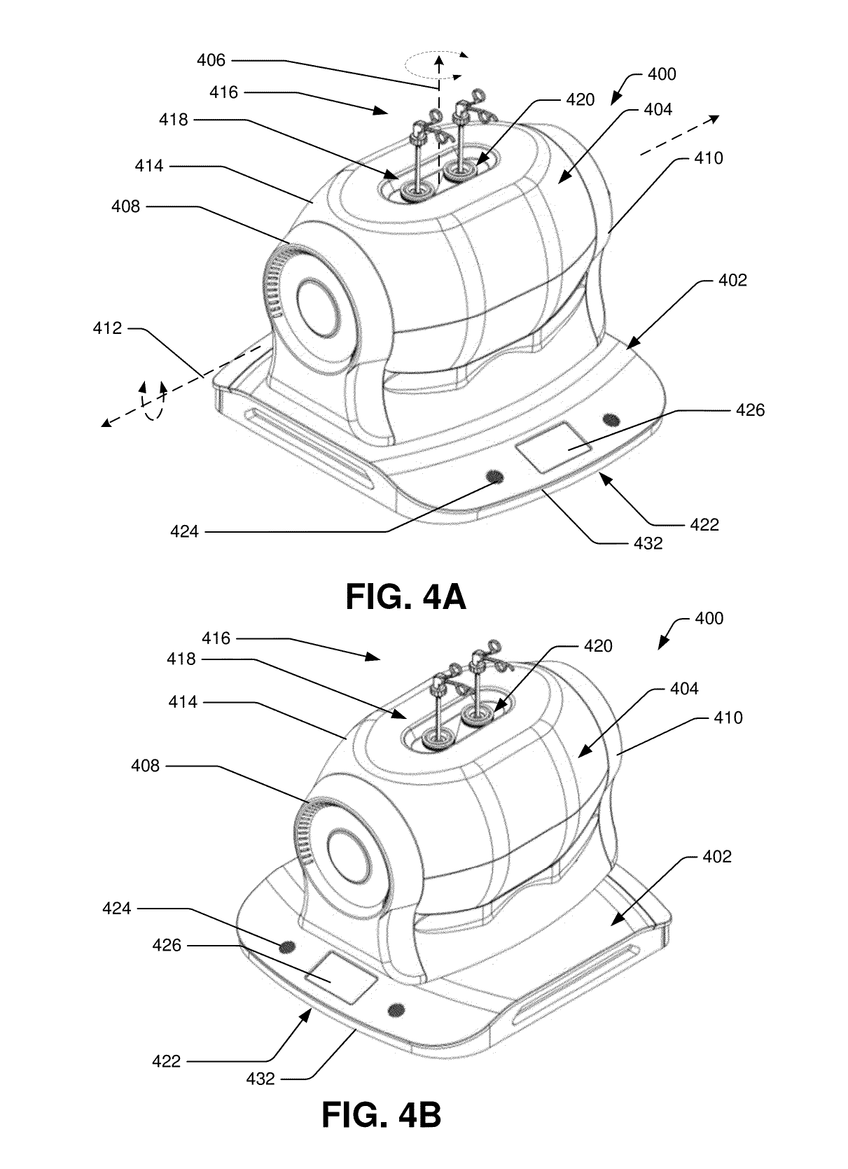

FIGS. 4A-4D are isometric views, from various points of view, of an example haptic interface device 400 that may be employed to implement the haptic interface device 208 of FIG. 2, according to one illustrated embodiment. The points of view are elevated left-hand side, elevated right-hand side, elevated right hand side, and right hand side, in FIG. 4A, FIG. 4B, FIG. 4C and FIG. 4D, respectively.

The haptic interface device 400 includes a base 402 and a main body assembly 404. In the illustrated embodiment, the main body assembly 404 is rotatably coupled to the base 402 and is rotatable around axis 406, which is approximately vertical. In FIG. 4B, the main body assembly 404 is shown rotated by approximately 90 degrees about the vertical axis 406. Referring to FIG. 4D, the base 402 of the haptic interface device 400 may be coupled to a podium 432. The podium 432 may be configured to raise and lower the base 402.

The main body assembly 404 includes first and second ends 408 and 410, which define a main-body longitudinal axis 412. The main body assembly 404 includes a central body member 414 that extends between the first and second ends 408 and 410, respectively. The central body member 414 is coupled to the first and second ends 408 and 410, respectively, to be rotatable about the main-body longitudinal axis 412. In FIG. 4D, the central body member 414 is shown rotated by approximately 45 degrees about the main-body longitudinal axis 412.

The base 402, first and second ends 408 and 410, respectively, and central body member 414 may be made from resilient materials such as, but not limited to, metal or plastic. In some embodiments, the central body member 414 may have an exterior surface that may be sized and shaped to approximately correspond to a torso of a human. The central body member 414 may be generally hollow and provide a housing for components of the haptic interface device 400.

A pair of tools 416 extend outward from a cover assembly 418. The tools 416 may be grasped and manipulated by a user of the haptic interface device 400, and the tools 416 may be coupled to the central body member 414 to be individually rotatable, pivotable, and slidable with respect to the central body member 414.

In some embodiments, the cover assembly 418 may be comprised of a resilient material such as metal or plastic and may define ports 420 through which the tools 416 extend into a hollow interior of the central body member 414. The cover assembly 418 may be configured such that the ports 420 may be movable relative to each other. In some embodiments, the ports 420 may be translated in directions that are generally parallel to the main-body longitudinal axis 412. In some embodiments, the ports 420 may be translated in directions that are generally perpendicular to the main-body longitudinal axis 412. In yet other embodiments, the ports 420 may be translated in directions that include components that are generally perpendicular and/or generally parallel to the main-body longitudinal axis 412.

The base 402 includes a front user side 422 having audio interface devices such as speakers and microphones 424 and a display device 426, which may be a touch sensitive interface. In some embodiments, the display device 426 displays system information such as menus from which the user may select options. For example, various training exercises and/or training programs may be displayed on the display device. In some embodiments, the user may select from the menu of options by touching the desired menu item. In some embodiments, the user may select from the menu of options by manipulating the tools 416. In some embodiments, the user may select from the menu of options by uttering commands, which the audio interface devices 424 may provide to a voice-recognition system.

In some embodiments, the display device 426 may display configuration information for the haptic interface device 400. Configuration information may include settings for the main-body assembly (e.g., amount of rotation about axis 406), central body member (e.g., amount of rotation about main-body longitudinal axis 412), and ports 420 (e.g., relative locations of the ports 420). The configuration information may be based on a selected exercise. For example, the haptic interface device 400 may be configured differently for an exercise involving laparoscopic kidney surgery without a robotic surgical system and kidney surgery with a robotic surgical system.

In some embodiments, the display device 426 may display a virtual patient's torso overlayed with images of ports 420. The user may then configure the haptic interface device 400 to correspond to the image of the virtual patient's torso. In some embodiments, the display device 426 provide an indication that the haptic interface device 400 is properly configured. For example, the overlayed images of the ports 420 may change color when the haptic interface device 400 is properly configured.

The user may select a training procedure such as, but not limited to, a laparoscopic kidney procedure. In some embodiments, the haptic interface device 400 may then be automatically configured to provide a training simulation of the selected training procedure. In some instances, the main body assembly 404, the central body member 414, the ports 420, and the height of the podium 432 may be automatically positioned to predetermined locations for performing the selected training procedure. Configurations of the main body assembly 404, the central body member 414, the ports 420, and the podium 432 for various training procedures may be stored in memory of the surgical simulator/slave controller 200. The main body 404, the central body member 414, the ports 420, and the height of the podium 432 may be driven to predetermined locations by various motors/drivers.

In some embodiments, the haptic interface device 400 may include a handle 428. The handle 428 may be manually turned to rotate the central body member 414 about the main-body longitudinal axis 412. In some embodiments, there may be indicia of gradations on the haptic interface device 400 to provide an indication of the amount of rotation applied to the central body member 414. In some embodiments, the indicia of gradations may be proximal to the handle 428.

In some embodiments, the haptic interface device 400 may also include a handle 430, which may be manually turned to drive the ports 420 towards or away from each other, or in some embodiments, to drive one of the ports 420. In some embodiments, there may be indicia of gradations on the haptic interface device 400 to provide an indication of the amount of separation of the ports 420. In some embodiments, the indicia of gradations for port separation may be proximal to the ports 420.

In many real-world events, a person performing a task is limited in the positions in which they can perform the task. For example, a patient-side surgeon, assisting in a robotic surgical procedure, may have to perform various tasks from a fixed position so as to be out of the way of the robot. The fixed position may not be optimal position for performing the patient-side tasks. For example, the patient-side surgeon may be forced to reach along the length of the patient's torso and/or lean over the patient. The haptic interface device 400 may be configured to emulate real-world situations. In particular, the haptic interface device 400 may be positioned such that a user standing at the front user side 422 has to reach for the tools 416 in the same manner as would a person performing a real-world task.

In some embodiments, the haptic interface device 400 may also include one or more sensors 432. The sensors 432 may be proximity sensors may be positioned and directed to detect whether a user is present or absent from the front user side 422. The sensors 432 may be optical or infra-red sensors and may be disposed proximal to, or along, the front user side 422. In some embodiments, the proximity sensors may be pressure sensitive and may be disposed in/on a mat or other surface, positioned in front of the front user side 422, upon which a user stands. In some embodiments, the haptic interface device 400 may be configured to provide training exercises and/or to operate only when the sensors 432 detect the presence of the user. The sensors 432 may be utilized to ensure that the user practices operation of the haptic interface device 400 at the front user side 422 regardless of the configuration of the haptic interface device 400.

In some embodiments, the haptic interface device 400 may include additional ports which may be utilized for instruments such as cameras. These additional ports may also be movable.

In some embodiments, the haptic interface device 400 may include attachments that may be removably coupled to the central body member 414 at various locations. These attachments may correspond to items typically found in at a real-world slave-side auxiliary station 116. These attachments may be placed on the central body member 414 so as to force the user of the haptic interface device 400 to perform tasks in a realistic environment.

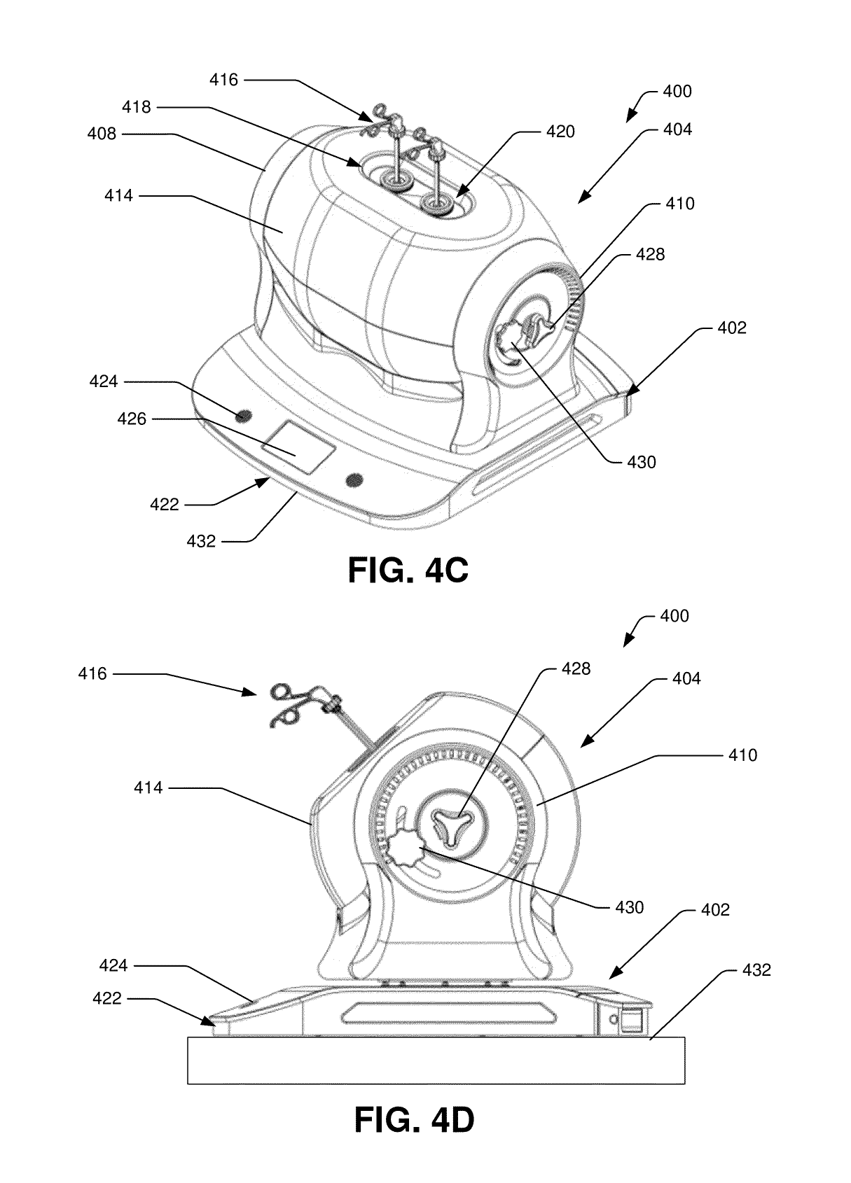

FIGS. 5A and 5B are front and side views of example internal components of the haptic user interface device 400, according to one illustrated embodiment.

The haptic user interface device 400 includes a first and a second cable-based effector units 502 and 504, respectively. The first and second cable-based effector units 502 and 504 are movably coupled to a frame-driver assembly 506. In the illustrated embodiment, the frame-driver assembly 506 is coupled to the handle 530 by a belt 508. Rotations of the handle 430 may cause the belt 508 to drive a screw mechanism of the frame-driver assembly 506, which in turn may drive the first and second cable-based effector units 502 and 504 to move towards or away from each other.

The cable-based effector units 502 and 504 may include a plurality of support members 510. The support members 510 may carry cover assembly 418 and cable tensioner assemblies 512. The cover assembly 418 may include a first and a second cover member 514 and 516, respectively. The cover members 514 and 516 may be slidably coupled or slidably interlocked together and may be rotatably coupled to ports 420. When the first and the cable-based effector units 502 and 504 are driven towards or away from each other, the first and the second cover members 514 and 516 are rotated about the ports 420 and slide relative to each other. In conjunction with the central body member 404, the cover assembly 418 provides, in some embodiments, a solid, resilient cover to the interior of the central body member 404. The cover assembly 418 may, among other things, block dust from entering the interior of the central body member 404.

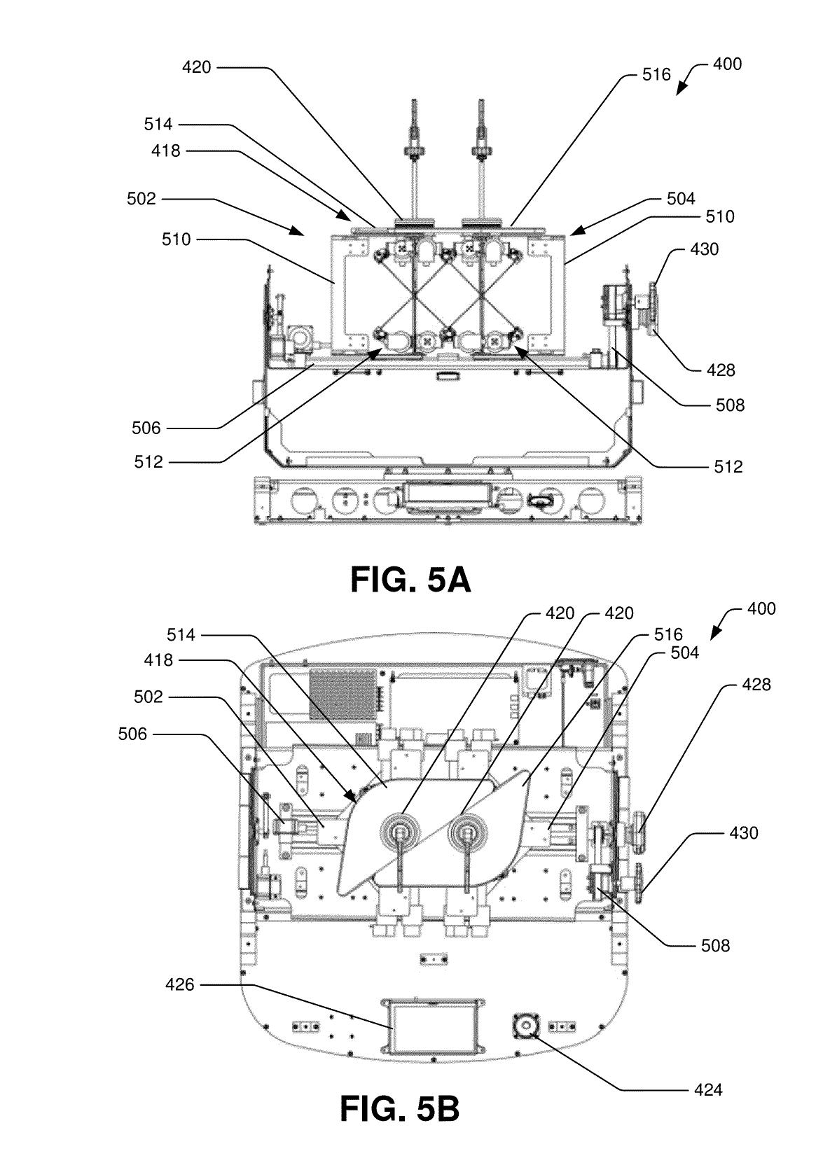

FIG. 6 shows a side view of an example tool 416. The tool 416 includes a user end 602 and an effector end 604, with a longitudinal shaft 606 extending therebetween. In some embodiments, the user end 602 includes a grip portion 608 that is configured to be grasped by a hand of a user. In the illustrated example tool 416, the grip portion 608 includes handles such as those found on forceps or scissors. In some embodiments, the user end 602 includes a wheel 610, which may be spun by a user, and a mode-selector switch 612. The sensors that detect motion of the wheel 610 and/or the mode selection of the mode-selector switch 612 are in communication with the central controller 206. The communication may be via wireless devices such as, but not limited to, Bluetooth devices and/or via wire connections such as, but not limited to, USB devices and/or a combination of wireless and wire devices. In some instances, a communications wire may extend between the tool 416 and a communications device. The central controller 206 may utilize the communications from the tool 416 to, among other things, engage a virtual clutch, provide a menu of options, highlight items of the menu, and select items from the menu.

The mode-selector switch 612 may be toggled by a digit of the user to set the tool 416 into various modes such as, clutch-mode, input-mode, and tool-mode. In tool-mode, the tool 416 may be manipulated as a tool. In clutch-mode, a virtual clutch may be engaged such that movements of the tool 416 do not cause a corresponding virtual-tool to be moved. In input-mode, the tool 416 may be utilized as an input device such as a mouse.

In some instances, the wheel 610 may be used like a scroll wheel for selecting options in a menu. The user end 602 may include sensors for detecting rotations of the wheel 610. In some instances, the wheel 602 may be spun to engage a virtual clutch. While the virtual clutch is engaged, rotations of the user end 602 do not result in corresponding rotations of a virtual-tool. In some instances, the wheel 602 may be spun to engage a real clutch such that the user end 602 may be rotated about the shaft 606 without resulting in rotations of the shaft 606.

In some instances, the grip portion 608 may be manipulated by a user to provide user input. For example in menu-mode, the user end 602 may include sensors which determine the relative positions of members of the grip portion 608, and the grip portion 608 may be squeezed to make a selection of a highlighted menu item. In tool mode, the sensors may determine the relative positions of the members of the grip portion 608, and a virtual-tool and/or a slave subsystem 112 may be manipulated to correspond to the movement of the members of the grip portion 608.

In some embodiments, the user end 602 may be removably coupled to the shaft 606. In such embodiments, the user end 602 may include grip portions that correspond to, among others, BiPolar forceps, Maryland forceps, cautery/dissection hook, curved scissors, straight scissors, micro scissors, irrigation cannula, cautery spatula, needle holder (straight), needle holder (curved), gallstone forceps, hook scissors, hemoclip applicator, bowel grasper, traumatic grasper (w/serrated teeth), deBakey grasper (vascular), Babcock grasping forceps, Allis grasping forceps, and right angle grasping forceps.

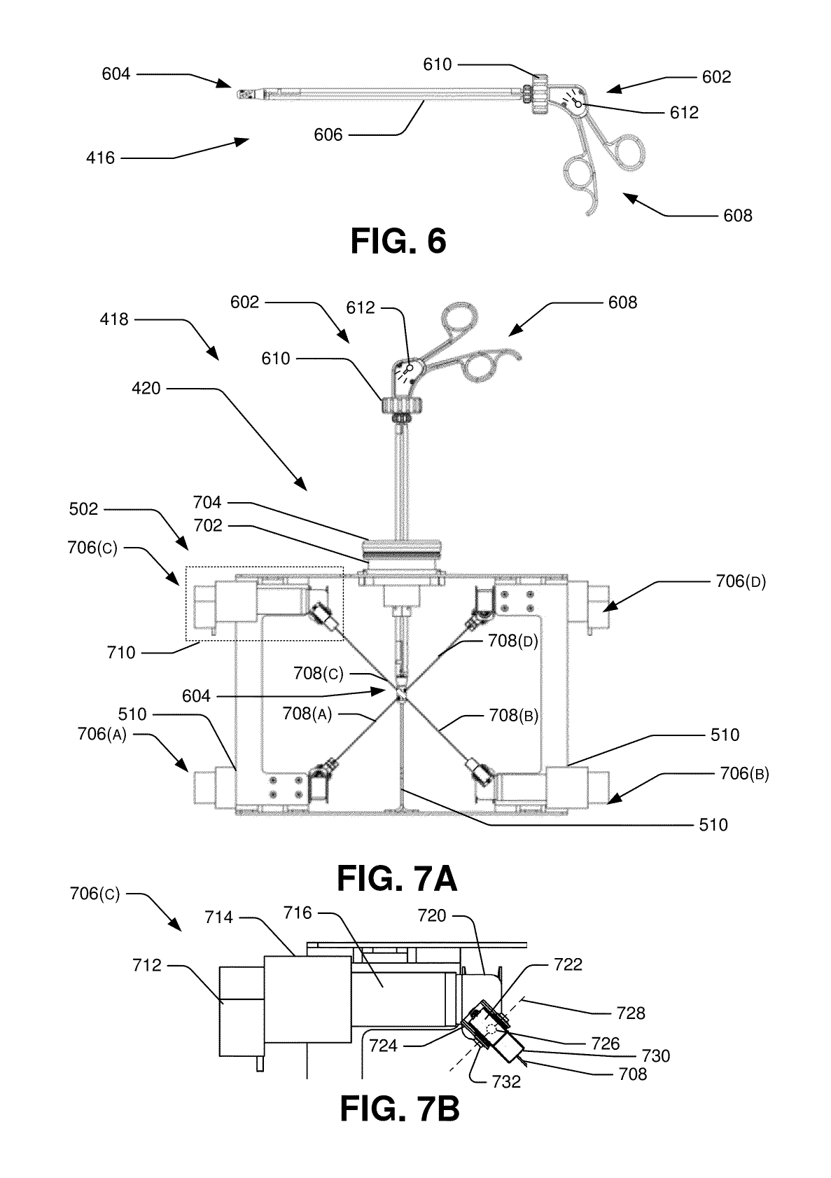

The effector end 604 is configured to couple to a plurality of cable segments 708 (see FIGS. 7A and 7B). In some embodiments, the effector end 604 defines a number of passages 614 through which cable segments 708 may be feed through. Plugs (not shown) may be the cable segments 708 at opposite ends of the passages 614 so that the cable segments 708 are fixedly fastened to the effector end 604. In some embodiments, the effector end 604 may include cable coupling members (not shown) for coupling ends of individual cable segments 708 to the effector end 604. The effector end 604 may be rotatably coupled to the shaft 606, which allows the shaft 606 to be spun/rotated freely by the user end 602 without causing rotational motion of the effector end 604. Consequently, the user end 602 may be rotated without causing the cable segments 708 to be wrapped around the tool 416. In some embodiments, the effector end 604 may be removably coupled to the shaft 606.

FIG. 7A is a side view of a cable-based effector unit 502, as seen along the main-body longitudinal axis 412, and tool 416. The port 420 includes a gimbal 702 and a grommet 704. The grommet 704 may be a pliable material such as rubber and may cover the gimbal 702 and be configured to allow the shaft 606 of the tool 416 to pass therethrough. The grommet 704 may protect the gimbal 702 from dirt and dust.

The gimbal 702 may be coupled to one or more of the support members 510 and may include a plurality of sensors. The plurality of sensors may be an attitude and heading reference system sensor array. In some embodiments, the plurality of sensors may include gyroscopes, accelerometers, and magnetometers configured to measure movement on three axes. In some embodiments, the gimbal plurality of sensors may provide sensor information that may be absolute location/orientation information, i.e., the location and/or the orientation of the gimbal 702 may be determined from sensor information. In contrast, relative location/orientation information may be used to determine the location and/or orientation of the gimbal 702 relative to another known location/orientation.

The gimbal 702 defines an opening that is sized and shaped to be complementary to the transverse cross-sectional size and shape of the shaft 606, and the opening and the shaft 606 may have transverse cross-sectional shapes that are non-circular, such as, but not limited to, square, rectangular, oval, elliptical, hexagonal, triangular, etc. The non-circular cross-sectional shapes of the opening of the gimbal 702 and the shaft 606 allows the shaft 606 to engage and rotate the gimbal 702 when the shaft 606 is rotated. The gimbal plurality of sensors may detect rotations of the gimbal 702. In some embodiments, the gimbal plurality of sensors may be configured to detect insertion length of the shaft 606 through the gimbal 702. For example, the shaft 606 may include indicia that may be detected by an optical encoder. Signals from the optical encoder would correspond to the shaft 606 being inserted or withdrawn through the gimbal 702.

The cable-based effector unit 502 includes a plurality of cable tensioner assemblies, individually referenced as 706(a)-706(d) and collectively referenced as 706, which are coupled to support members 510. In the illustrated embodiment, there are four cable tensioner assemblies 706, which are coupled to the support members 510 at vertices of a hexahedron such as, but not limited to, a cube or a rectangular prism. The cable tensioner assemblies 706 may be coupled at non-adjacent vertices of the hexahedron. For example, assume a rectangular prism has dimensions of 2A×2B×2C, and define an origin at the center of the rectangular prism. Then the cable tensioner assemblies 706 (or portions thereof) may be disposed at vertices having coordinates of (−A, −B, C), (A, B, C), (−A, B, −C) and (A, −B, −C).

Cable segments, individually referenced as 708(a)-708(d) and collectively referenced as 708, extend from the cable tensioner assemblies 706 to the effector end 604. In some embodiments, multiple cable segments 708 may comprise a single cable. For example, cable segments 708(a) and 708(b) may be segments of a single cable that is fixedly coupled to the effector end 604, and similarly cable segments 708(c) and 708(d) may be segments of a single cable that is fixedly coupled to the effector end 604. However, in other embodiments, one or more of the cable segments 708 have a first end fixedly coupled to the effector end 604 and a second end coupled to one of the cable tensioner assemblies 706.

FIG. 7B is an enlargement of a portion of the cable-based effector unit 502 bounded by box 710. The enlarged portion shows the cable tensioner assembly 706(c), which may be representative of all of the cable tensioner assemblies 706.

The cable tensioner assembly 706 may include an encoder 712, a brake 714, and a motor 716. The cable tensioner assembly 706 may be communicatively coupled to a cable tensioner controller, which may provide and receive signals to and from the HC computing device 216. In some embodiments, the cable tensioner assembly 706 may include an analog-digital (A/D) converter. The motor 716 may be an electrical motor and may be responsive to digital signals. The motor 716 drives a cable spool to pay out and retract cable segment 708. The motor 716 may be configured to fractionally rotate the spool, which allows incremental amounts of the cable segment 708 to be played out or retracted. Tension in the cable segment 708 may be controlled by selective driving of motor 716.

The encoder 712 may be an optical encoder configured to detect rotations of a component of the cable tensioner assembly 706 such as, but not limited to, a shaft of the motor 716, a cable spool, and/or a pulley, etc. The encoder 712 converts the detected rotations into electrical pulses that are provided to the HC computing device 216. In some embodiments, the encoder 712 may advantageously take the form of a relative encoder avoiding the expense associated with absolute encoders. In some embodiments, the A/D converter may be embodied at the HC computing device 216.

The brake 714 may be configured to be lockable and be configured to prevent rotations of the motor 716 and/or other components of the cable tensioner controller 712 such as, but not limited to, a shaft of the motor 716, a cable spool, and/or a pulley, etc. In some embodiments, the brake 714 may be actuated (and/or released) responsive to a change in a power state of the simulator/slave controller system 102 and/or the haptic interface device 204. For example, brake 714 may actuated when the power changes downward, e.g., the simulator/slave controller system 102 and/or the haptic interface device 204 is turned off; and/or the simulator/slave controller system 102 and/or the haptic interface device 204 is placed in sleep-mode. Similarly, the brake 714 may be released when the power changes upward.

The cable tensioner assembly 706 also includes a cable spool housing 720 and a cable guide housing 722. The cable guide housing 722 is pivotably coupled to a bracket 724, which is rotatably coupled to the spool housing 720. The bracket 724 rotates about an axis 726, which is approximately perpendicular to the sheet having FIG. 7B. The cable guide housing 722 pivots about an axis 728. The axes 726 and 728, which may be orthogonal to each other, provide two degrees of freedom to the cable guide housing 722. The cable guide housing 722 may include a pulley having its rotational axis aligned with axis 728.

Cable segment 708 extends outward from end 730 of the cable guide housing 722 to the effector end 604 of the tool 416. Whenever the effector end 604 is moved, the cable 708 is also moved, and movement of the cable 708 causes the cable guide housing 722 to move about its two degrees of freedom, i.e., to rotate about axis 726 and/or pivot about axis 728. The rotations and pivots of the cable guide housing 722 cause the cable guide housing 722 to be aligned with the cable 708 and to be pointed towards the effector end 604. The cable guide housing 722 may include sensors 732, such as encoders, for detecting the rotations and pivots of the cable guide housing 722. The sensors 732 converts the detected rotations and/or pivots into electrical pulses that are provided to the HC computing device 216.

In some embodiments, the encoders 716 may have a fast refresh rate in comparison to the refresh rate of the plurality of sensors of the gimbal 702. The HC computing device may use the encoder sensor data to determine current positions of the effector ends 604 and may use the gimbal sensor data to recalibrate the calculated positions of the effector ends 604.

The vector sum of the tensions in cable segments 708(a)-708(d) provide a net force to the effector end 604 of the tool 416. The net force is transmitted through the shaft 606 to the user end 602. Thus, force feedback can be applied to the user through tension in cables 708.

It should be noted that in some embodiments, not all components of a cable tensioner assembly 712 are disposed at one of the vertices of the regular prism having dimensions of 2A×2B×2C. In such embodiments, the motors 714, encoders 716, brake 714 and spool housing 720 with accompanying spool may be located elsewhere with the cable guide housing 722 located at one of the vertices of the regular prism. The cable segment 708 may extend from the cable guide housing 722 to the location of the spool housing 720 and may be guided thereto by a number of cable guide features and elements such as cable conduits and pulleys, etc.

### Illustrative Calibration Operations

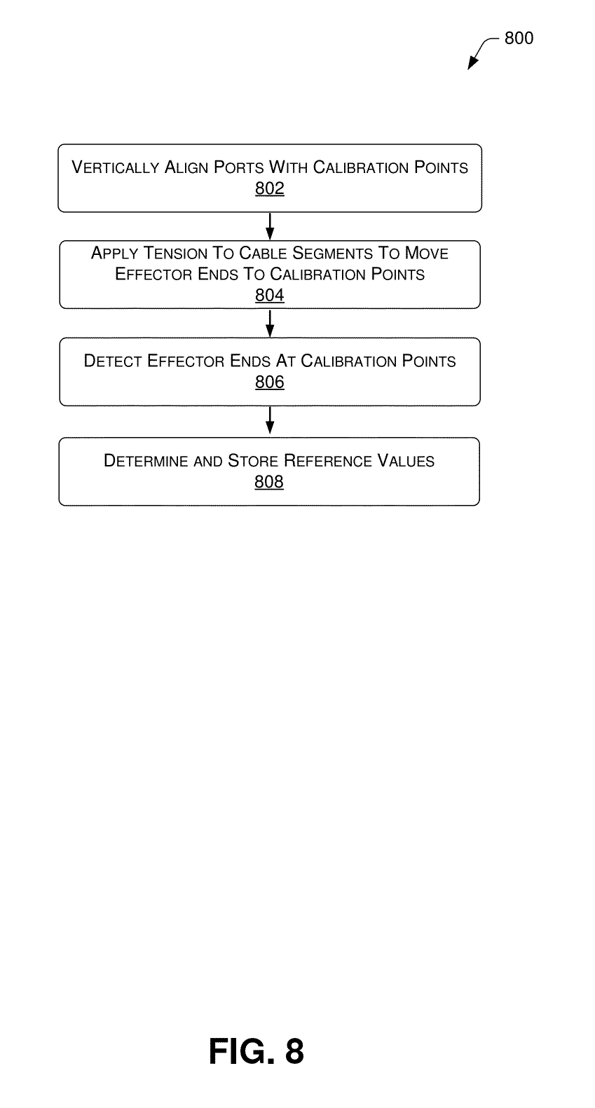

FIG. 8 is a flow diagram of an illustrative process 800 to calibrate the haptic interface device 400. The process 800 is illustrated as a collection of blocks in a logical flow graph, which represent a sequence of operations that can be implemented in hardware, software, or a combination thereof. The collection of blocks is organized under respective entities that may perform the various operations described in the blocks. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Other processes described throughout this disclosure, in addition to process 800, shall be interpreted accordingly.

At 802, a power state of the simulator/slave controller system 102 and/or the haptic interface device 400 changes from a low power mode to a higher power mode. In some instances, the change in power may correspond to the simulator/slave controller system 102 and/or the haptic interface device 400 being turned on, and in other instances, the change in power may correspond to the simulator/slave controller system 102 and/or the haptic interface device 400 transitioning out of sleep mode.

At 802, the ports 420 are vertically aligned with a calibration point. In some instances, this may involve rotations of the central body member 414.

At 804, the effector end 604 is moved to a predetermined calibration point. In some instances, the predetermined calibration point may be the geometric center of the regular prism defining the vertices where the cable tensioner assemblies 706 are located or more particularly where the cable guide housing housings 722 are located. The effector end 604 may be moved to the calibration point by applying tensions to cables 708(a)-708(d), which are vector added at the effector end 604. Assume for a moment that the tool 416 is massless and the magnitudes of the tensions in cables 708(a)-708(d) are equal, then the net force applied to the massless effector end 604 is only balanced at the center of the regular prism. In other words, if massless effector end 604 is not located at the center of the regular prism, it will be drawn there by the net force being applied thereto.

However, the tool 416 is not massless, and consequently, there downward force of mg (mass×gravity) acting on the effector end 604. Consequently, in some embodiments, the magnitudes of the tension in cable segments 708(c) and 708(d) is greater than the magnitudes of the tension in cable segments in 708(a) and 708(b). The difference in the magnitudes of the cable tensions is approximately equal to mg such that the effector end 604 is pulled to the calibration point by the tension in cable segments 708.

At 806, detect effector ends 604 located at the calibration points. Once the effector end 604 is located at the calibration point, the net force acting on the effector end 604 is zero, and the effector end 604 is stationary. The HC computing device 216 recognizes that the effector end 604 is located at the calibration point by the lack of signals from the encoders 712. The HC computing device 216 may determine the orientation of the tool 416 from the sensor data provided by the plurality of sensors in the gimbal 702.

At 808, determine reference values that may be used for calculating the position and/or orientation of the tools 416 and store same. The HC computing device 216 may then set and store various reference values based at least in part on data from the sensors (e.g., encoders 716 and other sensors including gimbal sensors). It should be noted that some absolute sensors such as magnetometers of the gimbal sensors may drift over time when the gimbal 702 is held stationary. In that case, the HC computing device 216 may be configured to utilize the first gimbal sensor data that is received after the gimbal 702 is held stationary, and to ignore subsequent gimbal sensor data until the gimbal 702 is moved again. The HC computing device 216 may determine that the gimbal 702 is stationary or moving based at least in part on signals from the encoders 716. Typically, the encoders 716 provide signals at a much higher refresh rate than do the gimbal sensors.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A dual-handed haptic interface device, comprising:
a base having a front user side;
a main body assembly rotatably coupled to the base such that the main body assembly rotates about an axis that is generally vertical, the main body having opposed first and second ends which define a main body longitudinal axis;
a central body member rotatably coupled to the main body member, such that the central body member rotates about the main body longitudinal axis, the central body member having a generally hollow interior with a pair of cable-based effector units disposed therein;
a pair of ports, wherein at least one port is configured to move in at least one direction in a plane defined by the central body member; and
a pair of tools coupled to the pair of ports, each tool having a user end and an effector end with an elongated shaft that extends between the user end and the effector end, wherein each shaft extends through a respective one of the pair of ports and is slidably coupled thereto, and wherein each effector end is coupled to a plurality of cable segments of a respective one of the pair of cable-based effector units.

2. The dual-handed haptic interface device of claim 1, further comprising:
a support member configured to couple to a bottom surface of the base and configured to raise and lower the base.

3. The dual-handed haptic interface device of claim 1, further comprising:
a display device, disposed on a front user-side surface of the base, for providing a graphical user interface for the dual-handed haptic interface device.

4. The dual-handed haptic interface device of claim 1, further comprising:
a control device configured to provide control signals to the pair of cable-based effector units, wherein the pair of cable-based effector units pay out and retract the plurality of cable segments in response thereto.

5. A dual-handed haptic interface device, comprising:
a base having a front user side;
a main body assembly rotatably coupled to the base such that the main body assembly rotates about an axis that is generally vertical, the main body having opposed first and second ends which define a main body longitudinal axis;
a central body member rotatably coupled to the main body member, such that the central body member rotates about the main body longitudinal axis; and
a pair of ports, wherein at least one port is configured to move in at least one direction in a plane defined by the central body member.

6. The dual-handed haptic interface device of claim 5, further comprising:
a pair of gimbals, each gimbal coupled to a respective one of the pair of ports and each gimbal defining an opening and having a plurality of sensors configured to measure an orientation of the respective gimbal.

7. The dual-handed haptic interface device of claim 7, wherein the plurality of sensors is an attitude and heading reference system sensor array:

8. The dual-handed haptic interface device of claim 7, wherein the plurality of sensors includes a gyroscope, accelerometer, and magnetometer configured to measure at least one of position, orientation, and movement on three axes.

9. The dual-handed haptic interface device of claim 7, further comprising:
a pair of tools coupled to the pair of gimbals, each tool having a user end and an effector end with an elongated shaft that extends between the user end and the effector end, wherein each shaft extends through the opening of a respective one of the pair of gimbals and is slidably coupled thereto.

10. The dual-handed haptic interface device of claim 9, wherein the plurality of sensors of at least one gimbal includes an encoder configured to measure translational motion of the shaft of the tool coupled to the at least one gimbal.

11. The dual-handed haptic interface device of claim 5, further comprising:
a pedestal coupled to an underside of the base, the pedestal configured to raise and lower the base.

12. The dual-handed haptic interface device of claim 5, further comprising:
a port drive mechanism for translating at least one of the pair of ports.

13. The dual-handed haptic interface device of claim 12, wherein the port drive mechanism is manually powered.

14. The dual-handed haptic interface device of claim 5, further comprising at least one of:
a main body driver configured to drive the main body assembly about rotations of the generally vertical axis;
a central body member driver configured to drive the central body member about rotations of the main body longitudinal axis; and
a port driver configured to drive at least one port in the at least one direction.

15. A haptic interface device, comprising:
a port having at least one translational degree of freedom and at least two rotational degrees of freedom; and
a gimbal coupled to the port, the gimbal defining an opening and having a plurality of sensors; and
a tool having a user end and an effector end with an elongated shaft that extends between the user end and the effector end, wherein the shaft extends through the opening of the gimbal and is slidably coupled thereto.

16. The haptic interface device of claim 15, wherein the port is a first port, the gimbal is a first gimbal, and the tool is a first tool, and further comprising:
a second port having at least one translational degree of freedom and at least two rotational degrees of freedom; and
a second gimbal coupled the second port, the second gimbal defining an opening and having a plurality of sensors; and
a second tool having a user end and an effector end with an elongated shaft that extends between the user end and the effector end, wherein the shaft extends through the opening of the second gimbal and is slidably coupled thereto.

17. The haptic interface device of claim 15, further comprising:
a user detection sensor configured to detect a user being located at a front side of the haptic interface device.

18. The haptic interface device of claim 17, wherein the haptic interface device evaluates user performance and demerits the user performance responsive to the user detection sensor failing to detect the user being located at the front side of the haptic interface device.

19. The haptic interface device of claim 17, wherein the haptic interface device freezes operation responsive to the user detection sensor failing to detect the user being located at the front side of the haptic interface device.

20. The haptic interface device of claim 15, further comprising:
a plurality of cable segments coupled to the effector end of the tool; and
a cable-based effector unit having a plurality of cable tensioner assemblies, each cable tensioner assembly including a motor, a brake, and a spool having one of the cable segments of the plurality of cable segments coupled thereto, each cable tensioner assembly configured to pay out and retract the respective cable segment coupled thereto.
